(19) United States
(12) Patent Application Publication
(10) Pub. No.: US 2007/0077168 A1
(43) Pub. Date: Apr. 5, 2007

(54) Alcohol-in-breast milk analysis test kit

(76) Inventor: Bryarly A. Szalczyk, Phoenix, MD (US)

Correspondence Address: OBER/KALER;c/o Royal W. Craig, Suite 800, 120 East Baltimore Street, Baltimore, MD, 21202, US

(21) Appl. No.: 11/543,733

(22) Filed: Oct. 5, 2006

Related U.S. Application Data
(60) Provisional application No. 60/723,852, filed on Oct. 5, 2005.

(51) Int. Cl. G01N 31/22

(52) U.S. Cl. 422/56

(57) ABSTRACT

The present invention is a test kit comprising a plurality of individually-sealed test strips, each for detecting the presence and intensity of alcohol in breast milk. Each test strip is formed from a porous (absorbent) carrier matrix, and a color-change reagent resident on the carrier matrix. The color-change reagent comprises an alcohol oxidase enzyme and a hydrogen donor indicator that changes color when oxidized. In addition, a comparative color chart is provided, including a plurality of color swatches, a numerical scale of blood alcohol concentration, and a quantitative safe/not safe warning. The reagent on the test strip indicates the presence of alcohol in breast milk. The test kit includes a number of test strips and a color chart to allow breast feeding mothers to ascertain the concentration of alcohol in their breast milk to ensure that breast milk fed to infants is free of alcohol.

### CROSS-REFERENCE TO RELATED APPLICATIONS

The present application derives priority from U.S. provisional patent application No. 60/723,852 filed 05 Oct. 2005.

### BACKGROUND OF THE INVENTION 1. Field of the Invention

The present invention generally relates to alcohol testing and, more particularly, to an alcohol test kit specifically adapted for quantifying alcohol in breast milk. 2. Description of the Background

Breast milk is widely regarded as the preferred source of nutrition for infants. However, mothers must follow certain guidelines when feeding their infants in this manner; they must especially watch what they eat and drink. This is necessary because drugs and alcohol are passed from mother to child in breast milk. Hale, T, Medications and Mothers Milk 1999-2000 (8th ed. 1999); Riordan et al., Breastfeeding and Human Lactation, (2nd ed. 1999). Maternal alcohol abuse also may affect an infant's sucking reflex, weight gain and rate of development. Alcohol in quantity far short of abuse can still cause significant effect. For example, just a small bit of alcohol in breast milk can negatively affect infant sleep patterns. Mennella and Gerrish, Pediatrics Vol. 101 No. 5 May 1998, p. e2. In addition, moderate alcohol ingestion by a mother on a regular basis (more than 1 gm/kg daily/frequently) has a negative effect on milk production. No matter how a woman feeds her baby, her ability to safely care for an infant or child is affected when alcohol is overused in a single sitting or abused through regular overuse.

Alcohol enters and leaves breast milk at about the same rate as it enters and leaves a woman's blood stream (about 1 oz/hr). Thus, as alcohol is filtered from the blood, it also is cleaned from the milk. An occasional “social” drink (by a mother) does not appear to be a risk for most breastfed babies, and the American Academy of Pediatrics (AAP) considers limited maternal consumption (less than 1 g/kg daily) to be compatible with breastfeeding. Some experts believe the alcohol in breast milk from one drink is diluted when it enters the baby's bloodstream and so does not pose a risk to a healthy infant. However, some physicians advise mothers to wait about 2 hours after finishing a single beverage before breastfeeding again or to wait about two hours for each drink consumed if a woman has more than one beverage. Of course, delaying breastfeeding for a period of several hours while waiting for the alcohol to clear from the maternal system may contribute to such maternal complaints as plugged ducts or mastitis. Thus, it becomes necessary to “pump and dump” the breast milk.

Because of the quantitative guidelines set forth above, it would be greatly advantageous to provide a quantitative way to measure the amount of residual alcohol in breast milk so that a mother can make an informed decision as to whether to use her existing milk, or pump and dump.

It is well known how to test an individual to determine the extent to which he/she is under the influence of alcohol. Such tests also have wide applicability in agricultural settings such as determining alcohol levels in silage and can even be employed in amateur wine-making. A comprehensive discussion of test strips as to both their chemistry and techniques of manufacture and use may be found in U.S. Pat. Nos. 4,361,648 and 4,362,697. These patented schemes are concerned with testing a wide variety of body fluids for cholesterol, glucose and dextrose and include the suggestion of peroxidase and peroxidase-like substances as catalysts in promoting the color change reaction. These are amenable to implementation on a test strip, and it is generally known that test strips are a convenient test medium: adaptable to use in the home and by comparatively unskilled users. It would be greatly advantageous to adapt the foregoing technology in order to provide a test kit including an test-strip indicator for detecting clinically significant amounts of alcohol in breast milk.

### SUMMARY OF THE INVENTION

It is a primary object of the present invention to provide an alcohol-in-breast milk analysis test kit to detect the presence and concentration of alcohol in human breast milk.

It is yet another object of the present invention to provide a simple-to-use, in home test kit including a plurality of test strips for detecting the presence and intensity of alcohol in breast milk.

It is another object to help breast feeding mothers be responsible.

It is still another object to ensure that breast milk being passed on to infants is free of alcohol.

In accordance with the foregoing and other objects, the present invention is a test kit comprising a plurality of individually-sealed test strips, each for detecting the presence and intensity of alcohol in breast milk. Each test strip is formed from a porous (absorbent) carrier matrix, and a color-change reagent resident on the carrier matrix. The color-change reagent comprises an alcohol oxidase enzyme and a hydrogen donor indicator that changes color when oxidized. In addition, a comparative color chart is provided, including a plurality of color swatches, a numerical scale of blood alcohol concentration, and a quantitative safe/not safe warning. The reagent on the test strip indicates the presence of alcohol in breast milk. The test kit includes a number of test strips and a color chart to allow breast feeding mothers to ascertain the concentration of alcohol in their breast milk to ensure that breast milk fed to infants is free of alcohol.

### BRIEF DESCRIPTION OF THE DRAWING

Other objects, features, and advantages of the present invention will become more apparent from the following detailed description of the preferred embodiments and certain modifications thereof when taken together with the accompanying drawing in which:

FIG. 1 is a front view of the components of the Breast Milk Analysis Test Kit 1.

FIG. 2 illustrates an exemplary color change chart 10.

### DETAILED DESCRIPTION OF THE PREFERRED EMBODIMENT

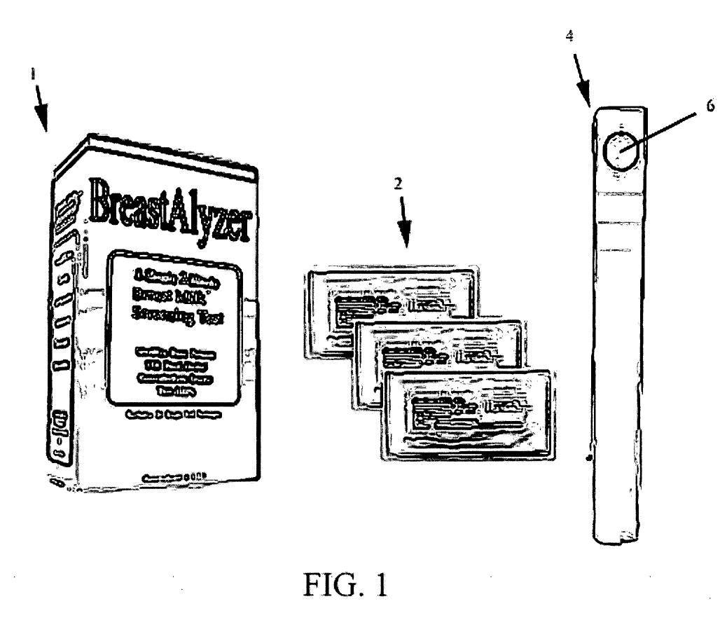

The present invention is an alcohol-in-breast milk analysis test kit to detect the presence and concentration of alcohol in human breast milk. FIG. 1 is a front view of the Breast Milk Analysis Test Kit according to the invention, which comprises a box 1 containing a plurality of individual sealed packages 2 of disposable strips 4, each strip 4 having a reactive pad 6 applied at the tip.

Whenever a breast feeding mother is concerned that alcohol may be present and in larger than safe quantities in her breast milk, each strip 4 allows a very simple one-step 2 minute test without instrumentation, calibration or special training. They are convenient enough to be used any time and any place. The mother retrieves and opens a package 2 to yield a single test strip 4. The pad 6 end of the test strip 4 is exposed to her breast milk for just a moment, allowing the strip material to saturate. The color change of the pad 6 will indicate whether and how much alcohol is present in the milk. This quickly and easily quantifies the amount of alcohol in her breast milk, and helps her to make a responsible decision and the mother can either pump and dump, or proceed and feel confident that the milk that she is passing to her child is safe, and free of alcohol. The entire test is rapid, highly sensitive, and a non-invasive way to detect the presence and amount of alcohol in breast milk.

The details of the strip 4 will now be described. Strip 4 is formed of a hydrophilic porous carrier matrix which allows for the absorption of aqueous milk into the matrix. A polyamide test strip formed with pores of an average diameter in the range of from about 0.6 to 1.0 um are well-suited for this purpose. The dimensions of the test strip 4 are on the order of two inches in length and one eighth to one quarter inch in width, and of any convenient thickness such as 5 to 10 thousandths of an inch. The carrier matrix may be bonded to a support strip such as polyester or other paper or plastic material which is inert as far as any reactions are concerned and functions simply as a means for manipulating the carrier matrix.

The carrier 4 is then dipped or coated with a reagent to form the pad 6. The reagent composition (per strip) is approximately as follows:

| | | |
|---|---|---|
| Tetramethylbenzidine | 0.176 | mg |
| Alcohol Oxidase | 0.5 | IU |
| Peroxidase | 30 | IU |
| Buffer | 0.747 | mg |
| Stabilizing Proteins | 0.190 | mg |

The active substances are alcohol oxidase (data sheet attached), an enzyme material, and peroxidase, an enzyme that catalyzes a reaction of the form:
ROOR′+electron donor (2 e−)+2H+→ROH+R′OH

The Tetramethylbenzidine is a noncarcinogenic peroxidase substrate that is pale blue in color and can be read spectrophotometrically at 370 or 620-650 nm.

The carrier 4 is dipped or coated with the above reagent to form the pad 6, and may be dipped a second time if desired to alter the color-change characteristics of the pad 6. The reagent pad 6 is then dried. As in the formation of other test strips such for pH measurement or the like, sheet of carrier 4 may be printed with pad 6, bonded to a plastic reinforcement sheet with adhesive, and then cut into strips.

In use, the pad 6 will rapidly turn shades of green to blue to gray upon contact with solutions of alcohol in breast milk, depending on the amount of alcohol present. A color change indicates the presence of alcohol, and the degree of color change quantifies the amount of alcohol in the breast milk sample. A comparison scale indicates whether the amount of alcohol in the breast milk sample is safe (generally, passing on the equivalent of one alcoholic beverage is considered safe). Preferably, the comparison scale is a color chart provided either on the box 1, sealed packages 2, or disposable strips 4, so that the mother can compare the color change in the pad 6 to the chart to objectively ascertain the alcohol concentration within the breast milk.

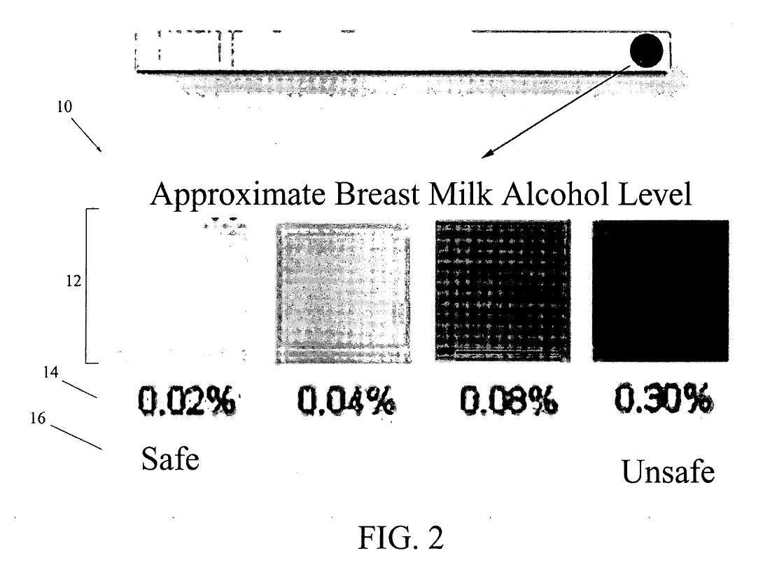

FIG. 2 illustrates an exemplary color change chart 10 that will help to quantify the green to blue coloration change intensity that occurs proportional to the alcohol concentration in the breast milk. There will be a color change in the presence of breast milk ranging from a light green-gray color at 0.02% blood alcohol concentration to a dark blue-gray color near 0.30% blood alcohol concentration. This color change is matched to color swatches 12 provided within this range to allow an approximation of the blood alcohol concentration to be made. In addition to the swatches 12, a numerical scale 14 is provided there beneath, and a quantitative safe/not safe warning 16 is provided at the bottom to interpret the color key shades and indicate whether it is safe to feed an infant the milk despite the presence of some alcohol (the equivalence of one alcoholic beverage is considered safe).

From the foregoing it is now apparent that the novel test strip of the present invention provides a simple-to-use, in home way for detecting the presence and intensity of alcohol in breast milk, and thereby helps breast feeding mothers be responsible and ensure that breast milk that is passed on to infants is free of alcohol.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A test strip for detecting the presence and intensity of alcohol in breast milk, comprising:
a porous carrier matrix;
a reagent coating said carrier matrix, wherein said reagent comprises an alcohol oxidase enzyme and a hydrogen donor indicator that changes color when oxidized; and
a comparative color chart including a plurality of color swatches, a numerical scale of blood alcohol concentration, and a quantitative safe/not safe warning provided at bottom of said chart, whereby said hydrogen donor indicator on said test strip changes color upon contact with solutions of alcohol in breast milk, and in conjunction with said color chart allows breast feeding mothers to ascertain the concentration of alcohol in their breast milk to ensure that breast milk fed to infants is free of alcohol.

2. A test strip for detecting the presence and intensity of alcohol in breast milk according to claim 1, wherein said hydrogen donor comprises tetramethylbenzidine.

3. A test strip for detecting the presence and intensity of alcohol in breast milk according to claim 1, wherein said reagent composition consists essentially of: tetramethylbenzidine, alcohol oxidase, peroxidase, buffer, and stabilizing proteins.

4. A test strip for detecting the presence and intensity of alcohol in breast milk according to claim 1, wherein said color of said hydrogen indicator is green, blue, or gray, depending on the amount of alcohol present in said breast milk.

5. A test strip for detecting the presence and intensity of alcohol in breast milk according to claim 1, wherein said blood alcohol concentration is in a range of 0.02% to 0.30% and said hydrogen indicator changes color and said comparative color chart allows mothers to ascertain whether it is safe to feed the baby their breast milk.

6. A test strip for detecting the presence and intensity of alcohol in breast milk according to claim 5, wherein said blood alcohol concentration is 0.02% and said color of said hydrogen indicator is a light green-gray color.

7. A test strip for detecting the presence and intensity of alcohol in breast milk according to claim 5, wherein said blood alcohol concentration is 0.30% and said color of said hydrogen indicator is a dark blue-gray color.

8. A test strip for detecting the presence of alcohol in breast milk, comprising:
a carrier material;
a reagent coating said carrier material, said reagent further comprising a reactive indicator for detecting presence of alcohol in breast milk.

9. A test strip for detecting the presence and intensity of alcohol in breast milk according to claim 8, wherein said reagent changes color when exposed to alcohol in breast milk.

10. A test strip for detecting the presence and intensity of alcohol in breast milk according to claim 9, wherein said reagent changes color in presence of alcohol when oxidized.

11. A test kit for detecting the presence and intensity of alcohol in breast milk using the test strip of claim 8, further comprising a comparative color chart including a plurality of color swatches.

12. A method for detecting the presence of alcohol in breast milk, comprising the steps of:
exposing a test strip to breast milk, said test strip comprising a carrier material having an alcohol-reactive indicator disposed thereon;
visually observing whether the reagent on said test strip changes color when exposed to said breast milk.
